(19) United States
(12) Patent Application Publication
(10) Pub. No.: US 2008/0095898 A1
(43) Pub. Date: Apr. 24, 2008

(54) Method For Welding Wafer Sheets And Product So Obtained

(75) Inventor: Sergio Mansuino, Mondovi' (Cuneo) (IT)

Correspondence Address: ROTHWELL, FIGG, ERNST & MANBECK, P.C., 1425 K STREET, N.W., SUITE 800, WASHINGTON, DC, 20005, US

(73) Assignee: SOREMARTEC S.A., Schoppach-Arlon (BE)

(21) Appl. No.: 11/577,428

(22) PCT Filed: Oct. 13, 2005
(86) PCT No.: PCT/EP05/55239

§ 371 Date: Apr. 18, 2007

(30) Foreign Application Priority Data
Oct. 18, 2004 (EP) 04425782.2

(51) Int. Cl. A21C 15/02; A21C 9/06

(52) U.S. Cl. 426/94; 426/138; 426/242; 426/274

(57) ABSTRACT

Method for welding wafer sheets and product so obtained A method for welding wafer sheet parts along reciprocal mat-ing surfaces, in which the parts are welded to each other by the moistening of the mating surfaces and adhesion by contact of said surfaces. Moistening is preferably carried out using water alone nebulised onto the mating surfaces. The method is particularly applicable to industrial production of wafer sheet shells, formed by mating two half-shells together rim to rim.

The invention relates to a method for welding to each other, along reciprocal mating surfaces, two or more parts consisting of wafer sheet and to the product obtained when said parts are mated together.

The invention has been developed with particular reference to use in the processes of manufacturing confectionery products comprising two half-shells or valves of wafer sheet connected to each other at the rim portions which face each other, so as to form a wafer shell, optionally including a filler product inside it.

For a general description of products of this type, reference may be made to European patents EP-B-0 083 324, EP-B-0 086 319 and EP-B-0 614 614, for example.

To connect the valves or half-shells to each other, EP-B-0 086 319 makes use of an additional material, consisting in the case in point of melted chocolate, deposited in a continuous line or in drops spaced apart from each other on the annular rim surfaces of the two half-shells.

EP-B-0 614 614 describes a method and a device for forming lines of welding between wafer sheets by using an alimentary adhesive material, consisting in the case in point of melted chocolate.

In view of the use of melted chocolate as an adhesive material, the methods described in the patents cited above do not provide adhesion between the wafer half-shells which is strong at a temperature higher than the melting temperature of the chocolate.

The primary purpose of the present invention is to provide a method of welding between sheet wafer parts which is strong even at temperatures higher than 33° C.

Another purpose of the present invention is to provide a method capable of being applied industrially, particularly on a continuous production line, without the need to employ relatively complex machines for depositing adhesive material, such as those described in EP-B-0 614 614.

According to the invention, these purposes are achieved by means of a method for welding sheet wafer parts along reciprocal mating surfaces, characterised in that said parts are welded to each other by the moistening of at least one of the mating surfaces and adhesion by contact of said surfaces.

Also constituting a subject of the invention is a product comprising at least a first and a second sheet wafer part welded to each other along reciprocal mating surfaces, which can be obtained using the method cited above and which has a weld area in which the wafer sheet material is modified, with respect to its original microsturcture, in that it has a structure resulting from moistening and subsequent drying of at least a thin surface layer of the mating surfaces.

Further characteristics of the method and of the product disclosed by the invention are cited in the appended claims.

The principle on which the invention is based consists essentially in the fact that moistening or wetting the wafer surfaces to be joined gives said surfaces properties of adhesion by reciprocal contact. The weld is therefore characterised by the substantial absence of cementing or adhesive materials between the parts welded. Consequently, the use of cementing or adhesive materials is not included in the invention.

The moistening agent used is preferably water in the liquid state. However, the invention does include the use of solutions or dispersions in water including small quantities of additives, which may be chosen from among the ingredients constituting the wafer batter used (described in what follows) and also from among starch, dextrins, maltodextrins, sugars and/or alimentary surfactants.

However, the total concentration by weight of these additives in water is not such that the solution or dispersion has properties adhesive in themselves. For example, appropriate levels of concentration by total weight of the above-mentioned additives might be less than 5% and preferably less than 2%.

The moistening agent is preferably applied to the surfaces to be joined by spraying, particularly by means of spraying by nebulising or atomising. The moistening may involve a thin surface layer of the parts to be joined. Adhesion occurs following contact between the moistened parts, followed by drying with evaporation of the moistening agent, optionally assisted by heating.

A particularly surprising fact is that with the use of the above-mentioned moistening agents, and in particular of water alone, it is possible to achieve strong adhesion by contact which gives the product resulting from the welding of wafer sheets adequate structural strength allowing it to be handled in the subsequent steps of industrial production where there are temperatures above 33° C.

It is probable that the adhesion by contact is the result of a dissolving action of the moistening agent with respect to the components of the wafer sheet material, though this explanation is not to be taken as binding in relation to the invention.

As far as the wafer sheet material is concerned, the solution according to the invention provides for the production of wafer according to the current process, using conventional batter formulation comprising a mixture of flour of flours in water, usually with the addition of ingredients such as milk, emulsifiers such as lecithin, raising agents etc.

As an example, a batter formulation may comprise the following ingredients:

| | | |
|---|---|---|
| Water | 40-60% | by weight |
| Flour | 30-45% | by weight |
| Sugars | 0.5-2% | by weight |
| Cocoa cake | 1-2% | by weight |
| Alimentary fats | 1.5-2.5% | by weight |
| Skimmed milk | 0.5-1.5% | by weight |

and further ingredients chosen from among sodium bicarbonate, salt, ammonium carbonate, soya lecithin, each of these, where present, being used in concentrations of not more than 0.5% by weight.

The batter is cooked in heated moulds to obtain wafers shaped in the form of half-shells.

Industrial methods for the preparation of the half-shells of wafer sheet to which the invention relates and structural morphological characteristics of these half-shells are described for example in EP-A-0 054 229, EP-A-0 221 033, WO97/48282 and US2004/137123 on behalf of the applicant, and reference may be made to these.

The morphological characteristics of the surfaces of the wafer half-shells to be joined depend on the production process by which the individual half-shells are obtained.

According to the method described in EP-A-0 054 229 and EP-A-0 221 033, individual half-shells are obtained from a wafer sheet which has a plurality of half-shells connected by an interconnecting wall, by means of a cutting operation carried out parallel to the plane of the interconnecting wall. In this case, the annular rim surfaces of the half-shells have a crumbly and porous surface resulting from the cutting operation, in which the porous internal structure of the wafer is exposed to the outside.

Alternatively, the annular rim surfaces may have a high degree of surface finish free from macropores, when the half-shells are obtained using the technologies described in US2004/137123.

In any case, the adhesion characteristics of the two half-shells, in the method according to the invention, are not substantially affected by the morphological characteristics of the surface to be welded, and these may therefore have a highly porous and/or crumbly structure or a high degree of surface finish, that is a smooth surface substantially free from macropores, or may also have a kind of surface skin.

In general, the wafer sheet, at least inside, has a porous cellular structure. The wetting of at least a thin surface layer of the parts to be welded and the subsequent welding by contact, with a slight pressure applied, may involve the collapse of the cells of the porous structure, so that in general the product of welding has a non-porous weld area formed by a thin layer with collapsed cells, the material composition of which is substantially identical to the composition of the wafer material constituting the parts welded.

The method according to the invention is suitable for application in a normal continuously operating cycle producing wafer shells, for example for the production of praline encased in wafer.

In this production process, typically rows of half-shells are arranged in corresponding cavities in a mould in the form of a plate, and rows of half-shells complementary to the first are arranged in another mould plate.

At this point, a metered amount of filler product of conventional type may be placed inside the individual half-shells; it should however by understood that the welding method disclosed by the invention is completely independent of whether or not there is a filler product inside the half-shells, since the welding method disclosed by the invention in no way relies on any cementing characteristics of the filler product.

In other words, the method according to the invention also applies to the production of hollow bodies of wafer sheet without any filling or filler product.

In the method of production indicated above, at this point the method according to the invention makes provision, for example, for spraying the nebulised moistening agents onto the moulds, which where applicable are in forward motion.

According to a preferred form of embodiment, before the moistening agent (nebulised water) is sprayed, a mask may be fitter onto the moulds, having a plurality of apertures corresponding in shape to the annular rim surfaces of the half-shells, and therefore capable of covering the cavities of each mould containing the half-shells, leaving uncovered only the above-mentioned annular rim surfaces to be mated together.

This measure is preferable in order to avoid wetting the inside containing wall of the half-shells and/or wetting the filler product or filling.

After the protective mask has be fitted, the nebulised water is sprayed onto the moulds, and because of the protective action of the mask is deposited only on the uncovered rim surfaces to be mated together.

The quantity of water or moistening agent applied is minimal relative to the weight of the water half-shell and preferably such that only a thin surface layer of the mating surfaces is wetted.

Next, after the protective mask is removed, the moulds are mated together by turning one mould over onto the other, so as to obtain adhesion of the rim surfaces of the complementary half-shells.

Finally, the mated moulds may be transferred to an evaporation station, to remove the moisture added when the nebulised water was applied. This last step of evaporation is to be understood as optional, though preferred in an industrial process. Said step of evaporation may be performed in various ways, such as for example exposing the shells to a flow of air (hot or cold) or treatment with microwaves or infrared rays.

The method according to the invention is preferably applied to the preparation of products formed by mating together half-shells of wafer which are small in size, for example of the order of 2.5-3 cm so that they can be consumed in one mouthful; however, the method is equally applicable to larger-sized products, such as for example snack bars comprising an internal wafer shell structure.

Similarly, it should be understood that the shape of the half-shells may vary widely and includes not only substantially semi-spherical shapes and but also elongated shapes and shapes with rims (that is mating surfaces) having different annular or non annular outlines, including circular, ovoid, polygonal or mixtilinear shapes.

Equally, the term “half-shell” is not limited to highly concave shapes, but may include substantially flat bodies.

The shell obtained by welding the half-shells may include filling or a filler product, introduced into the half-shells before welding, or may have no filler.

A liquid or semi-liquid filler may also be introduced into the welded shell by means of an aperture in one of the half-shells, produced when the half-shell is shaped in the mould, or made by means of a metering syringe or similar device. The structural strength of the welded shell is such as to permit the above-mentioned operation of syringe injection through the wall of the shell.

1. A method for welding wafer sheet parts along reciprocal mating surfaces, particularly to obtain a heat-resistant weld, characterised in that said parts are welded to each other by the moistening of at least one of the mating surfaces and adhesion by reciprocal contact of said surfaces.

2. A method according to claim 1, characterised in that moistening is carried out by application of a moistening agent consisting of water in the liquid state.

3. A method according to claim 1, characterised in that moistening is carried out by applying a moistening agent consisting of a solution or dispersion in water comprising additives selected from among starch, dextrins, maltodextrins, sugars and/or alimentary surfactants in quantities of not more than 5% by weight and preferably less than 2% by weight relative to said solution or dispersion.

4. A method according to claim 1, characterised in that moistening is carried out by application of a solution or dispersion in water containing one or more of the ingredients constituting the wafer batter, constituting the parts to be welded, in quantities of not more than 5% by weight and preferably less than 2% by weight relative to said solution or dispersion.

5. A method according to claim 2, characterised in that the moistening agent is applied to at least one of said mating surfaces by means of a distribution system, preferably by means of spraying by nebulising or atomising.

6. A method according to claim 1, characterised in that moistening is carried out so as to wet at least a thin surface layer in the mating surfaces.

7. A method according to claim 1, characterised in that said sheet wafer parts consist of a pair of half-shells of wafer sheet having annular rim surfaces intended for welding.

8. A method according to claim 1, for the production of wafer sheet shells formed by welding two half-shells of wafer sheet rim to rim:
supporting the half-shells to be welded to each other in respective support plates provided with cavities substantially complementary in shape to the walls of the half-shells;
applying to said support plates a mask provided with apertures corresponding in shape to the rim surfaces of the half-shells, so as to leave uncovered only said rim surfaces;
nebulising a moistening agent so as to cause moistening of at least a thin layer of the rim surface of said half-shells;
removing said mask and causing adhesion by contact of the complementary rim surfaces of the half-shells by turning one of said support plates over onto the other.

9. A method according to claim 1, characterised in that, following adhesion by contact, provision is made of drying out the parts of the welded half-shells, to cause evaporation of the moistening agent.

10. A method according to claim 9, in which the drying operation is carried out by means of treatment with microwaves, infrared rays, cold air or hot air.

11. A product comprising at least a first and a second sheet wafer part, welded to each other along a reciprocal mating surface, characterised in that it has a weld zone resulting from the moistening and subsequent drying out of a least a thin surface layer of said mating surfaces.

12. A product according to claim 11, characterised in that said weld zone is substantially free of added adhesive materials.

13. A product according to claim 11, characterised in that said weld zone is formed by a thin layer of wafer sheet material, substantially non-porous or with substantially collapsed cells.

14. A product according to claim 11, comprising two half-shells of wafer sheet, welded to each other along the respective annular rim surfaces.

15. A product according to claim 11, including a filling inside it.

16. A product according to claim 11, obtainable by means of a method for welding wafer sheet parts along reciprocal mating surfaces, particularly to obtain a heat-resistant weld, characterised in that said parts are welded to each other by the moistening of at least one of the mating surfaces and adhesion by reciprocal contact of said surfaces.
